(19) United States
(12) Patent Application Publication
(10) Pub. No.: US 2018/0239628 A1
(43) Pub. Date: Aug. 23, 2018

(54) HYPERVISOR AGNOSTIC CUSTOMIZATION OF VIRTUAL MACHINES

(71) Applicant: Nutanix, Inc., San Jose, CA (US)

(72) Inventors: Binny Sher Gill, San Jose, CA (US); Igor Grobman, San Jose, CA (US); Srinivas Bandi, Mountain View, CA (US); Abhishek Arora, San Jose, CA (US); Rahul Paul, Bangalore (IN); Aditya Ramesh, San Jose, CA (US)

(73) Assignee: Nutanix, Inc., San Jose, CA (US)

(21) Appl. No.: 15/439,559

(22) Filed: Feb. 22, 2017

(51) Int. Cl. G06F 9/455; G06F 9/44

(52) U.S. Cl. CPC G06F 9/45558; G06F 2009/45575; G06F 2009/45562; G06F 9/4406

(57) ABSTRACT

Examples of systems described herein include a computing node configured to execute a hypervisor and a hypervisor independent interface software layer configured to execute on the computing node. The interface software layer may be configured to determine configuration information and an operating system for a virtual machine to be created, receive an instruction to create the virtual machine through the hypervisor independent interface software layer, convert the instruction to create the virtual machine into a hypervisor specific command, create a virtual machine instance responsive to the hypervisor specific command, generate an image file by accessing a customization tool library from a plurality of customization tool libraries based, at least in part, on the customization information operating system for the virtual machine, attach the image file to the virtual machine, and power on the virtual machine instance.

### TECHNICAL FIELD

Examples described herein pertain to distributed and cloud computing systems. Examples of hypervisor agnostic customization of virtual machines are described.

### BACKGROUND

A virtual machine or a “VM” generally refers to a specific software-based implementation of a machine in a virtualized computing environment, in which the hardware resources of a real computer (e.g., CPU, memory, etc.) are virtualized or transformed into underlying support for the virtual machine that can run its own operating system and applications on the underlying physical resources just like a physical computer.

Virtualization generally works by inserting a thin layer of software directly on the computer hardware or on a host operating system. This layer of software contains a virtual machine monitor or “hypervisor” that allocates hardware resources dynamically and transparently. Many different types of hypervisors exist, such as ESX(i), Hyper-V, XenServer, etc. Typically, each hypervisor has its own unique application programming interface (API) through which a user can interact with the physical resources. For example, a user can provide a command through the particular API of the hypervisor executing on the computer to create a new VM instance in the virtualized computing environment. The user may specify certain properties of the new VM through the API, such as the operating system of the VM.

Multiple operating systems can run concurrently on a single physical computer and share hardware resources with each other as provisioned by the hypervisor. By encapsulating an entire machine, including CPU, memory, operating system, and network devices, a virtual machine is completely compatible with most standard operating systems, applications, and device drivers. Most modern implementations allow several operating systems and applications to safely run at the same time on a single computing node, with each operating system having access to the resources it needs when it needs them.

In many traditional virtualized computing environments, a virtual machine launched in the computing environment may be automatically provisioned or customized at boot up time with the help of VM customization tools, such as Cloud-init (for Linux VMs) or Sysprep (for Windows VMs). The boot image of the VM typically has the customization tool pre-installed therein, and the customization tool runs when the VM is powered on. The customization tool can discover the user-specified configuration which is then applied to the VM. The user-specified configuration for the VM can be applied to the VM through a disk image file, such as an ISO image file attached to the VM, prepared as specified by the discovery protocol of the customization tool.

### SUMMARY

Examples of systems are described herein. An example system may include a computing node configured to execute a hypervisor and a hypervisor independent interface software layer configured to execute on the computing node. The interface software layer is configured to determine configuration information and an operating system for a virtual machine to be created, receive an instruction to create the virtual machine through the hypervisor independent interface software layer, convert the instruction to create the virtual machine into a hypervisor specific command, create a virtual machine instance responsive to the hypervisor specific command, generate an image file by accessing a customization tool library from a plurality of customization tool libraries based, at least in part, on the customization information and the operating system for the virtual machine, attach the image file to the virtual machine, and power on the virtual machine instance.

Examples of methods are described herein. An example method may include determining configuration information and an operating system for a virtual machine to be created, receiving an instruction to create the virtual machine through a hypervisor independent interface software layer, converting the instruction to create the virtual machine into a hypervisor specific command, creating a virtual machine instance responsive to the hypervisor specific command, generating an image file by accessing a customization tool library from a plurality of customization tool libraries based, at least in part, on the customization information and operating system for the virtual machine, attaching the image file to the virtual machine, and powering on the virtual machine instance.

Another example method comprises providing configuration information for a virtual machine instance to a hypervisor agnostic interface software layer and providing an instruction to create the virtual machine instance through the hypervisor independent interface software layer. The hypervisor agnostic interface software layer is configured to determine an operating system for a virtual machine instance, convert the instruction to create the virtual machine instance into a hypervisor specific command, create the virtual machine instance responsive to the hypervisor specific command, generate an image file by accessing a customization tool library from a plurality of customization tool libraries based, at least in part, on the customization information and the operating system for the virtual machine to be created, attach the image file to the virtual machine instance, and power on the virtual machine instance.

Another example method comprises determining a type of a hypervisor configured to execute on a computing node, receiving a command having a first format through a hypervisor agnostic interface software layer, determining a hypervisor abstraction library associated with the type of hypervisor, wherein the hypervisor abstraction library is selected from a plurality of hypervisor abstraction libraries, converting the command having the first format to a command having a second format based, at least in part, on the hypervisor abstraction library, and providing the command having the second format to the hypervisor.

### BRIEF DESCRIPTION OF THE DRAWINGS

FIG. 1 is a block diagram of a distributed computing system, in accordance with an embodiment of the present invention.

FIG. 2 is a flowchart illustrating a method of generating a customized virtual machine in the distributed computing system of FIG. 1, in accordance with an embodiment of the present invention.

FIG. 3 is a flowchart illustrating a method of creating an image file, in accordance with an embodiment of the present invention.

FIG. 4A is a block diagram of a computing node, in accordance with an embodiment of the present invention.

FIG. 4B is a block diagram of the computing node of FIG. 4A with a customized virtual machine instantiated thereon, in accordance with an embodiment of the present invention.

FIG. 5 is a flowchart illustrating a method of converting a hypervisor agnostic command into a hypervisor specific command, in accordance with an embodiment of the present invention.

FIG. 6 is a block diagram of a computing node, in accordance with an embodiment of the present invention.

### DETAILED DESCRIPTION

Certain details are set forth below to provide a sufficient understanding of embodiments of the invention. However, it will be clear to one skilled in the art that embodiments of the invention may be practiced without one or more of these particular details. In some instances, wireless communication components, circuits, control signals, timing protocols, computing system components, and software operations have not been shown in detail in order to avoid unnecessarily obscuring the described embodiments of the invention.

Typical methods for customizing VMs may suffer from several limitations. Limitations are discussed herein by way of example and to facilitate appreciation for technology described herein. It is to be understood that not all examples described herein may address all, or even any, limitations of conventional systems. However, one limitation may be that creation of new VMs typically requires usage of hypervisor specific APIs. Therefore, if a user or process wishes to create a new virtual machine instance, the user or process typically needs specific knowledge of the hypervisor that is managing the virtualization environment. Each time a new hypervisor is introduced to the virtualized environment, a new API typically needs to be learned to enable creation of new VMs. Moreover, provisioning of a VM with an image file typically requires the user creating the VM to generate an image file in a specific manner in accordance with the operating system in which the VM will operate. There is therefore a need for a mechanism to abstract the creation of VMs to a hypervisor agnostic environment, while maintaining and automating the benefits of creating customized VMs based on user-specifications.

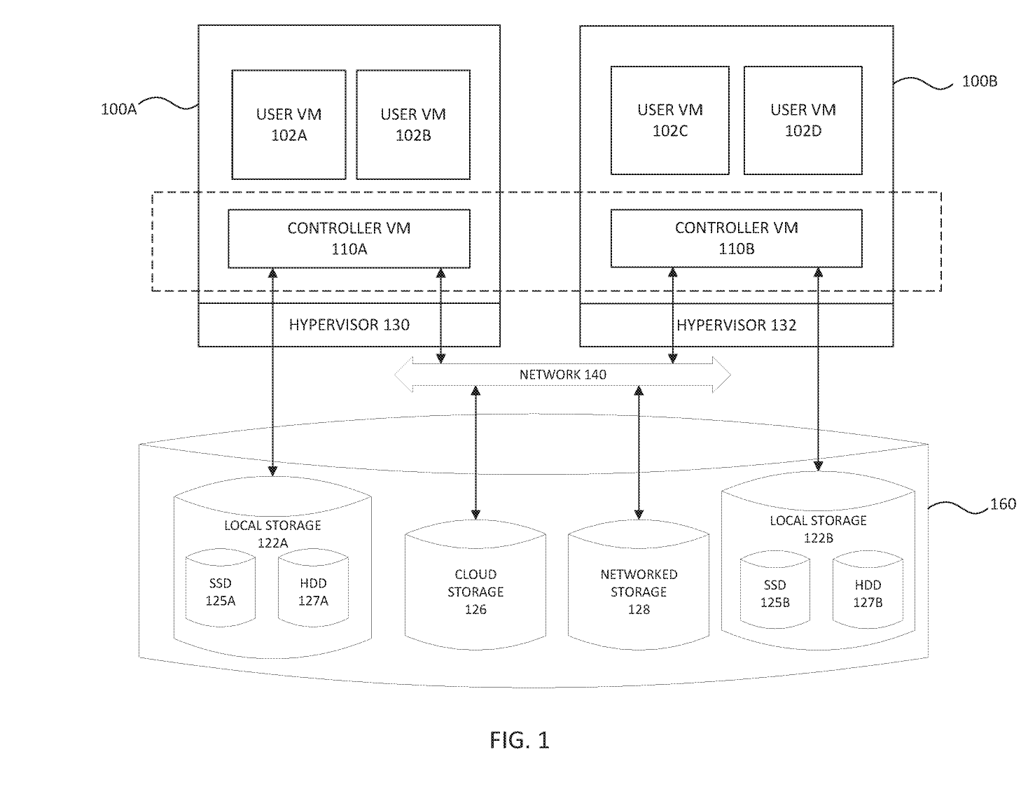

FIG. 1 is a block diagram of a distributed computing system, in accordance with an embodiment of the present invention. The distributed computing system of FIG. 1 generally includes computing nodes 100A, 100B and storage 160 connected to a network 140. The network 140 may be any type of network capable of routing data transmissions from one network device (e.g., computing nodes 100A, 100B and storage 160) to another. For example, the network 140 may be a local area network (LAN), wide area network (WAN), intranet, Internet, or a combination thereof. The network 140 may be a wired network, a wireless network, or a combination thereof.

The storage 160 may include local storage 122A, 122B, cloud storage 126, and networked storage 128. The local storage may include, for example, one or more solid state drives (SSD) 125A and one or more hard disk drives (HDD) 127A. Similarly, local storage 122B may include SSD 125B and HDD 127B. Local storages 122A, 122B may be directly coupled to, included in, and/or accessible by a respective computing node 100A, 100B without communicating via the network 140. Cloud storage 126 may include one or more storage servers that may be stored remotely to the computing nodes 100A, 100B and accessed via the network 140. The cloud storage 126 may generally include any type of storage device, such as HDDs SSDs, or optical drives. Networked storage 128 may include one or more storage devices coupled to and accessed via the network 140. The networked storage 128 may generally include any type of storage device, such as HDDs SSDs, or optical drives. In various embodiments, the networked storage 128 may be a storage area network (SAN).

The computing node 100A is a computing device for hosting VMs in the distributed computing system of FIG. 1. The computing node 100A may be, for example, a server computer, a laptop computer, a desktop computer, a tablet computer, a smart phone, or any other type of computing device. The computing node 100A may include one or more physical computing components, such as processors.

The computing node 100A is configured to execute a hypervisor 130, a controller VM 110A and one or more user VMs, such as user VMs 102A, 102B. The user VMs 102A, 102B are virtual machine instances executing on the computing node 100A. The user VMs 102A, 102B may share a virtualized pool of physical computing resources such as physical processors and storage (e.g., storage 160). The user VMs 102A, 102B may each have their own operating system, such as Windows or Linux. The user VMs 102A, 102B may also be customized upon instantiation. VMs. may be customized, for example, by loading certain software, drivers, network permissions, etc. onto the user VMs 102A, 102B when they are powered on (e.g., when they are launched in the distributed computing system).

The hypervisor 130 may be any type of hypervisor. For example, the hypervisor 130 may be ESX, ESX(i), Hyper-V, KVM, or any other type of hypervisor. The hypervisor 130 manages the allocation of physical resources (such as storage 160 and physical processors) to VMs (e.g., user VMs 102A, 102B and controller VM 110A) and performs various VM related operations, such as creating new VMs and cloning existing VMs. Each type of hypervisor may have a hypervisor-specific API through which commands to perform various operations may be communicated to the particular type of hypervisor. The commands may be formatted in a manner specified by the hypervisor-specific API for that type of hypervisor. For example, commands may utilize a syntax and/or attributes specified by the hypervisor-specific API.

The controller VM 110A includes a hypervisor independent interface software layer that provides a uniform API through which hypervisor commands may be provided. Throughout this disclosure, the terms “hypervisor independent” and “hypervisor agnostic” are used interchangeably and generally refer to the notion that the interface through which a user or VM interacts with the hypervisor is not dependent on the particular type of hypervisor being used. For example, the API that is invoked to create a new VM instance appears the same to a user regardless of what hypervisor the particular computing node is executing (e.g. an ESX(i) hypervisor or a Hyper-V hypervisor). The controller VM 110A may receive a command through its uniform interface (e.g., a hypervisor agnostic API) and convert the received command into the hypervisor specific API used by the hypervisor 130.

The computing node 100B may include user VMs 102A, 102B, a controller VM 110B, and a hypervisor 132. The user VMs 102A, 102B, the controller VM 110B, and the hypervisor 132 may be implemented similarly to analogous components described above with respect to the computing node 100A. For example, the user VMs 102C and 102D may be implemented as described above with respect to the user VMs 102A and 102B. The controller VM 110B may be implemented as described above with respect to controller VM 110A. The hypervisor 132 may be implemented as described above with respect to the hypervisor 130. In the embodiment of FIG. 1, the hypervisor 132 may be a different type of hypervisor than the hypervisor 130. For example, the hypervisor 132 may be Hyper-V, while the hypervisor 130 may be ESX(i).

The controller VMs 110A, 110B may communicate with one another via the network 140. By linking the controller VMs 110A, 110B together via the network 140, a distributed network of computing nodes 100A, 100B, each of which is executing a different hypervisor, can be created. The ability to link computing nodes executing different hypervisors may improve on typical distributed computing systems in which communication among computing nodes is limited to those nodes that are executing the same hypervisor. For example, computing nodes running ESX(i) may only communicate with other computing nodes running ESX(i). The controller VMs 110A, 110B may reduce or remove this limitation by providing a hypervisor agnostic interface software layer that can communicate with multiple (e.g. all) hypervisors in the distributed computing system.

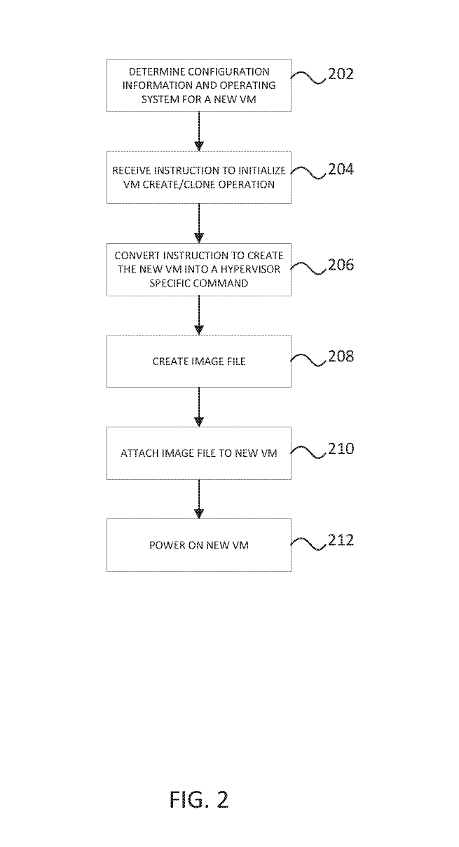

FIG. 2 is a flowchart illustrating a method of generating a customized virtual machine in the distributed computing system of FIG. 1, in accordance with an embodiment of the present invention. In operation 202, the computing node 100 determines configuration information and/or an operating system for a new VM to be created. The configuration information may include information regarding one or more customizable settings for the new VM to be created. For example, the configuration information may include a number of virtual processors or an amount of virtual memory to be included in the new VM, one or more drivers to load in the new VM, security provisions for the new VM, usernames, passwords, biographical information for an individual to be associated with the new VM, other authentication information, or information regarding any other customizable settings of the new VM. The configuration information and the operating system may be received, for example, through an API of a controller VM 110A, 110B. In another embodiment, the configuration information and/or the operating system may be derived for other information. For example, if the new VM is a clone of an existing user VM (e.g., one of user VMs 102A-D), the operating system and/or configuration information may be derived from the existing VM instance.

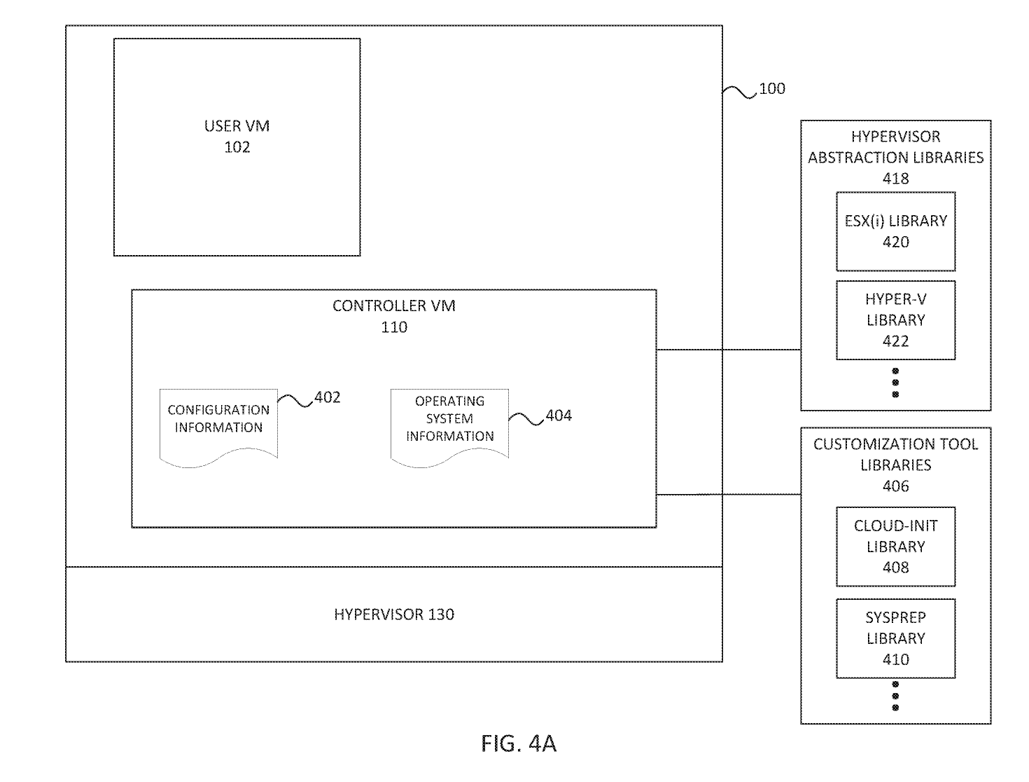

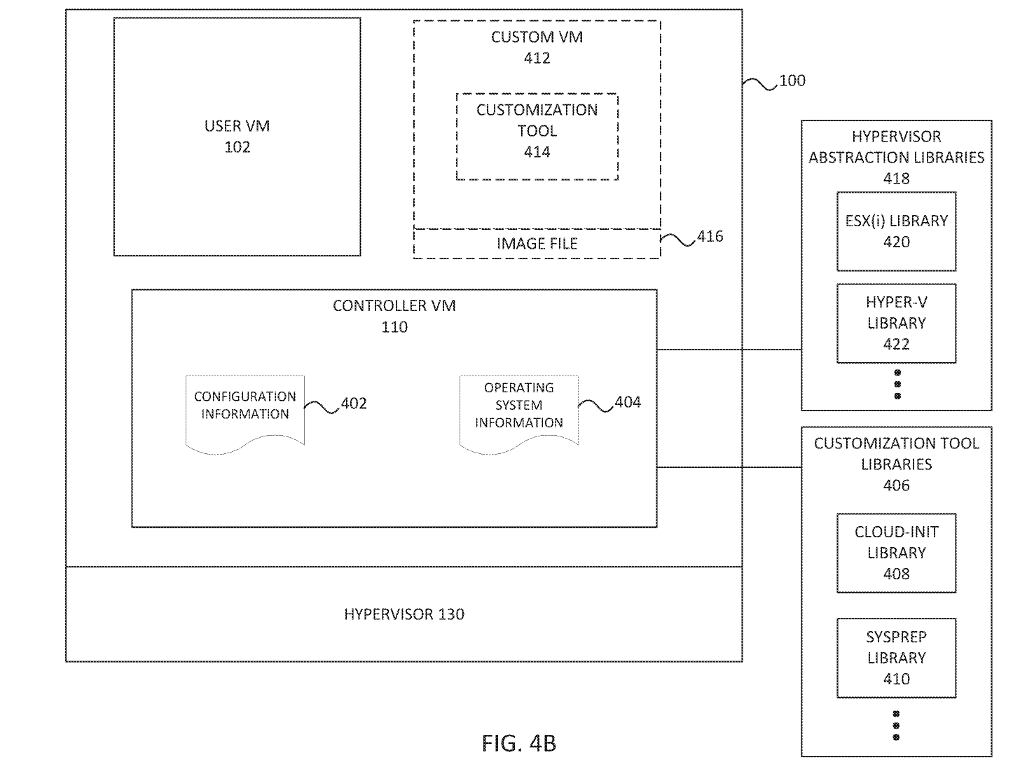

With reference to FIG. 4A, a computing node 100 is shown. The computing node 100 may be implemented as described above with respect to computing nodes 100A, 100B of FIG. 1. The computing node 100 may execute a hypervisor 130. The computing node 100 may also host one or more user VMs 102, which may be implemented as described above with respect to user VMs 102A-D of FIG. 1. The computing node 100 may further host a controller VM 110, which may be implemented as described above with respect to controller VMs 110A, 110B of FIG. 1. The controller VM 110 may determine configuration information 402 and operating system information 404 by, for example, receiving the configuration information 402 and operating system information 404 through an API of the controller VM 110 or by deriving the configuration information 402 and/or operating system information 404 from an existing user VM (e.g., user VM 102).

Returning again to FIG. 2, in operation 204, the computing node receives an instruction to initialize a VM create or a VM clone operation. The VM create/clone operation may be received, for example, through the hypervisor agnostic API of a controller VM, such as controller VM 110 of FIG. 4. Because the controller VM 110 is hypervisor agnostic, the user requesting the creation of the new VM does not need to know the particular type hypervisor 130 that the computing node 100 is executing, and the instruction to initialize a VM create or a VM clone operation may not be specific to any particular hypervisor type.

In operation 206, the controller VM converts the received instruction to initialize the create/clone VM operation into a hypervisor specific command.

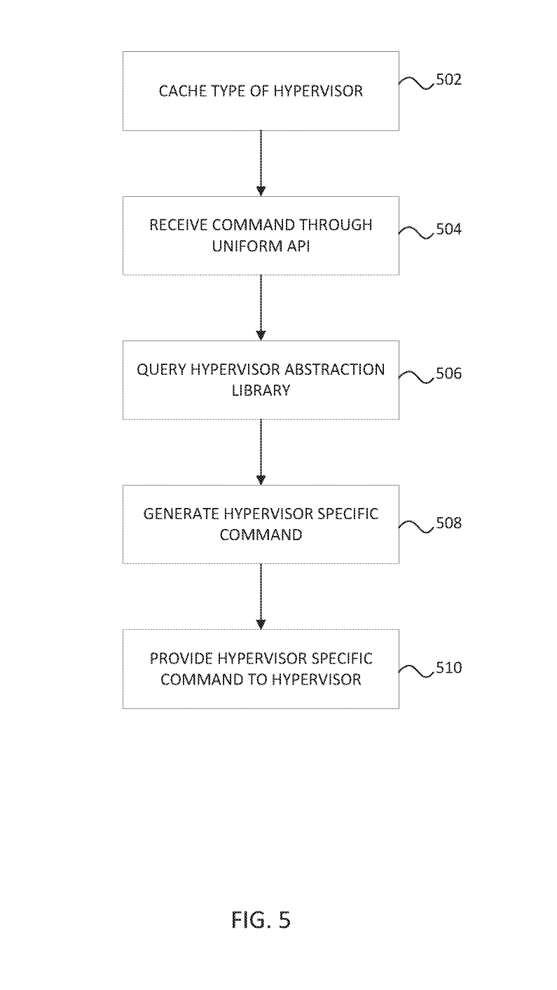

FIG. 5 is a flowchart illustrating a method of converting a hypervisor agnostic command into a hypervisor specific command, in accordance with an embodiment of the present invention. Although described herein with reference to a create/clove VM operation, it should be understood that the method of FIG. 5 may generally be used with any type of command that can be provided through the hypervisor agnostic interface software layer and converted into a hypervisor specific command. Such commands include, but are not limited to create VM, power on VM, power off VM, clone VM, delete VM, attach virtual disk to VM, detach virtual disk to VM, attach CD-ROM to VM, detach CD-ROM to VM, etc. In operation 502, the controller VM 110 caches the type of hypervisor 130. For example, the controller VM may store a type of hypervisor (e.g., ESX(i), Hyper-v, etc.). In operation 504, the controller VM 110 receives a command through a uniform API. For example, a user may provide a command (e.g., create/clone VM) using a uniform API of the controller VM 110. Providing a uniform API through the controller VM 110 enables users to interact with different types of hypervisors without learning multiple hypervisor specific APIs. For example, a user may provide a single create VM command, using a single command format regardless of the type of hypervisor executing on the computing node.

In operation 506, the controller VM 110 queries a hypervisor abstraction library. Referring to FIG. 4A, the controller VM 110 may be coupled to hypervisor abstraction libraries 418. The hypervisor abstraction libraries 418 may include one or more hypervisor specific libraries (e.g., ESX(i) library 420, hyper-V library 422, and more for additional types of hypervisors). The hypervisor specific libraries include translation information to convert commands from the hypervisor agnostic API of the controller VM to the hypervisor specific API of the hypervisor 130. The translation information may include, for example, formatting information for converting the format of the hypervisor agnostic command to the format of the hypervisor specific command. In the embodiment of FIG. 5, the controller VM 110 submits a query to the hypervisor abstraction libraries 418 based on the type of hypervisor 130 executing on the computing node 100 and the hypervisor agnostic command received. For example, the controller VM 110 may have cached that the hypervisor 130 is Hyper-v and received a hypervisor agnostic command to create a VM. The controller VM 110 may then submit a query for the create VM command to the Hyper-v library 422.

In operation 508, the controller VM 110 generates a hypervisor specific command. The controller VM 110 may receive the results of the query submitted to the hypervisor abstraction libraries 418 in operation 506 and convert the format of the hypervisor agnostic command received in operation 504 to a hypervisor specific command based on the results of the query. For example, the controller VM 110 may reformat the command into the hypervisor specific API of the hypervisor 130. In operation 510, the controller VM 110 provides the hypervisor specific command to the hypervisor 130. In response to receiving the hypervisor specific command, the hypervisor 130 may perform the command. The method of FIG. 5 is scalable to any number of commands and any number of different types of hypervisors. To add commands, conversion information can be added for each new command to each type of hypervisor library in the hypervisor abstraction libraries 418. Similarly, to add a new type of hypervisor, a new hypervisor library can be added to the hypervisor abstraction libraries 418.

In operation 208, the controller VM creates an image file. The image file may contain the configuration information for the new VM instance. The image file may be, for example, an ISO file, an XML file, or any other type of file that is discoverable and readable by the new VM instance to set one or more customizable settings.

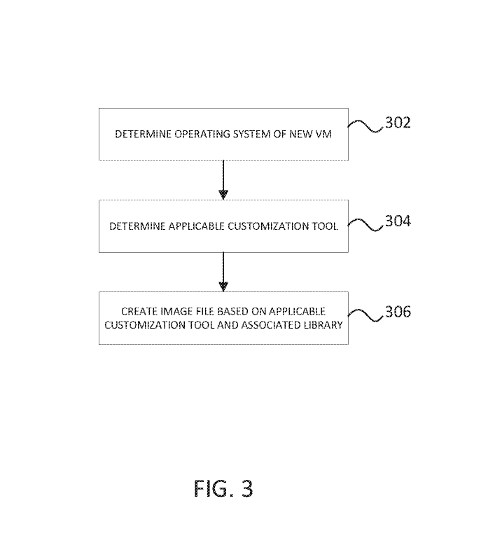

FIG. 3 is a flowchart illustrating a method of creating an image file, in accordance with an embodiment of the present invention. For example, the operations of FIG. 3 may be implemented as operation 208 of FIG. 2. In operation 302, the controller VM determines the operating system of the new VM. Referring to FIG. 4A, the controller VM 110 accesses the operating system information 404 to determine the operating system of the new VM.

Referring again to FIG. 3, in operation 304, the controller VM determines an applicable customization tool. A virtual machine launched in the computing environment may be automatically provisioned or customized at boot up time with the help of VM customization tools, such as Cloud-init (for Linux VMs), Sysprep (for Windows VMs). The boot image of the VM generally has the customization tool pre-installed therein, and the customization tool may run when the VM is powered on. The customization tool can discover the user-specified configuration which is then applied to the VM. Based on the operating system of the new VM determined in 302, the controller VM 110 determines which customization tool is pre-installed into the boot image of the new VM. For example, if the new VM has a Windows operating system, then Sysprep, the windows customization tool, may be pre-installed in the boot image of the new VM. Similarly, if the new VM has a Linux operating system, then Cloud-init, the Linux customization tool may be pre-installed in the boot image of the new VM. The above examples are intended to be illustrative only, and other operating systems and customization tools may be used.

In operation 306, the controller VM generates the image file based on the customization tool identified in operation 304 and an associated customization tool library. Referring to FIG. 4, the computing node 100 may access one or more customization tool libraries 406. The customization tool libraries 406 may be stored, for example, in storage 160 of FIG. 1. For example, the customization tool libraries 406 may include a Cloud-init library 408 and a Sysprep library 410. Each customization tool library includes customization tool specific commands and controls. The controller VM accesses the configuration information 402 and the customization tool library for the operating system of the new VM and generates an image file that includes commands to customize the new VM according to the configuration information 402 using the particular commands and controls in the selected customization tool library. For example, if controller VM 110 determines that the configuration information 402 specifies that the new VM should have a particular driver installed thereon and the new VM has a Windows operating system, then the controller VM 110 accesses the Sysprep library 410 and generates an image file according to the particular commands and controls that Sysprep uses. When the new VM is powered on, Sysprep, which is pre-installed on the new VM, can discover the image file and install the selected driver based on the commands and controls included in the image file.

Referring again to FIG. 2, once the image file is created in operation 208, which may be completed as described above with respect to FIG. 3, the controller VM attaches the image file to the new VM instance in operation 210. The image file may be appended to the boot image of the new VM such that, when the new VM is powered on, the pre-installed customization tool can discover the image file and customize the new VM accordingly. In operation 212, the new VM is powered on by the controller VM, and the image file is detected by the customization tool to customize the new VM.

FIG. 4B is a block diagram of the computing node of FIG. 4A with a customized virtual machine instantiated thereon, in accordance with an embodiment of the present invention. The computing node 100 now includes a new, custom VM 412. The custom VM 412 has a customization tool 414 (e.g., Sysprep or Cloud-init) pre-installed thereon and an image file 416 attached thereto. The image file 416 is prepared based on the customization tool 414, the operating system of the custom VM and the respective customization tool library (e.g., Cloud-init library 408 or Sysprep library 410).

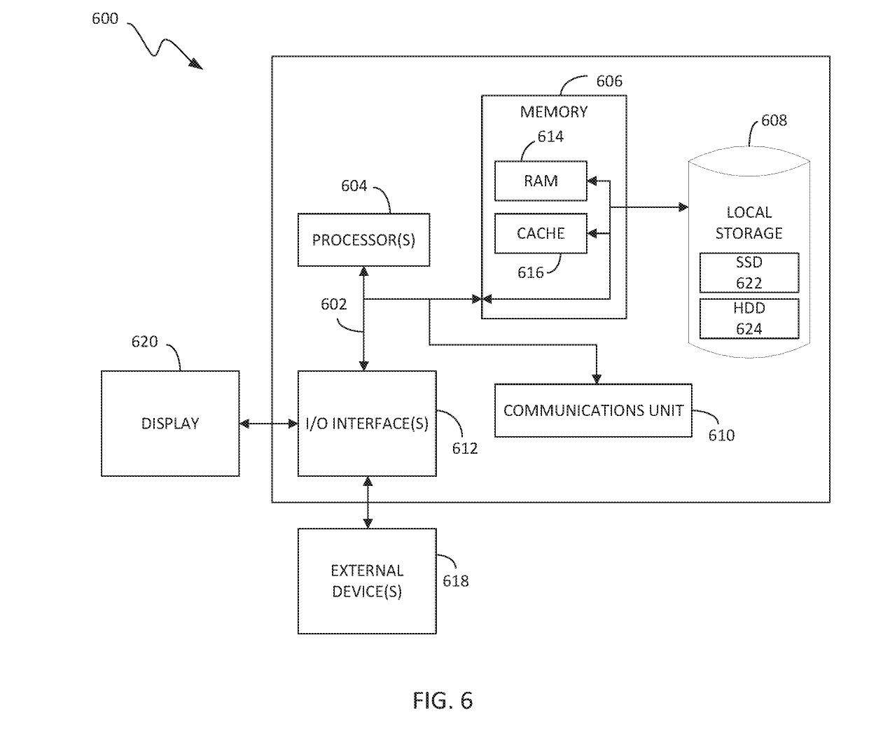

FIG. 6 depicts a block diagram of components of a computing node 600 in accordance with an embodiment of the present invention. It should be appreciated that FIG. 6 provides only an illustration of one implementation and does not imply any limitations with regard to the environments in which different embodiments may be implemented. Many modifications to the depicted environment may be made. The computing node 600 may implemented as the computing nodes 100, 100A, and/or 100B.

The computing node 600 includes a communications fabric 602, which provides communications between one or more computer processors 604, a memory 606, a local storage 608, a communications unit 610, and an input/output (I/O) interface(s) 612. The communications fabric 602 can be implemented with any architecture designed for passing data and/or control information between processors (such as microprocessors, communications and network processors, etc.), system memory, peripheral devices, and any other hardware components within a system. For example, the communications fabric 602 can be implemented with one or more buses.

The memory 606 and the local storage 608 are computer-readable storage media. In this embodiment, the memory 606 includes random access memory (RAM) 614 and cache memory 616. In general, the memory 606 can include any suitable volatile or non-volatile computer-readable storage media. The local storage 608 may be implemented as described above with respect to local storage 122A, 122B. In this embodiment, the local storage 608 includes an SSD 622 and an HDD 624, which may be implemented as described above with respect to SSD 125A, 125B and HDD 127A, 127B, respectively.

Various computer instructions, programs, files, images, etc. may be stored in local storage 608 for execution by one or more of the respective computer processors 604 via one or more memories of memory 606. In some examples, local storage 608 includes a magnetic hard disk drive 624. Alternatively, or in addition to a magnetic hard disk drive, local storage 608 can include the solid state hard drive 622, a semiconductor storage device, a read-only memory (ROM), an erasable programmable read-only memory (EPROM), a flash memory, or any other computer-readable storage media that is capable of storing program instructions or digital information.

The media used by local storage 608 may also be removable. For example, a removable hard drive may be used for local storage 608. Other examples include optical and magnetic disks, thumb drives, and smart cards that are inserted into a drive for transfer onto another computer-readable storage medium that is also part of local storage 608.

Communications unit 610, in these examples, provides for communications with other data processing systems or devices. In these examples, communications unit 610 includes one or more network interface cards. Communications unit 610 may provide communications through the use of either or both physical and wireless communications links.

I/O interface(s) 612 allows for input and output of data with other devices that may be connected to computing node 600. For example, I/O interface(s) 612 may provide a connection to external devices 618 such as a keyboard, a keypad, a touch screen, and/or some other suitable input device. External devices 618 can also include portable computer-readable storage media such as, for example, thumb drives, portable optical or magnetic disks, and memory cards. Software and data used to practice embodiments of the present invention can be stored on such portable computer-readable storage media and can be loaded onto local storage 608 via I/O interface(s) 612. I/O interface(s) 612 also connect to a display 620.

Display 620 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Those of ordinary skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Skilled artisans may implement the described functionality in varying ways for each particular application and may include additional operational steps or remove described operational steps, but such implementation decisions should not be interpreted as causing a departure from the scope of the present disclosure as set forth in the claims.

What is claimed is:

1. A system comprising:
a computing node configured to execute a hypervisor; and
a hypervisor independent interface software layer configured to execute on the computing node, wherein the interface software layer is configured to:
determine configuration information and an operating system for a virtual machine instance;
receive an instruction to create the virtual machine instance through the hypervisor independent interface software layer;
convert the instruction to create the virtual machine instance into a hypervisor specific command;
create the virtual machine instance responsive to the hypervisor specific command;
generate an image file by accessing a customization tool library from a plurality of customization tool libraries based, at least in part, on the configuration information and the operating system for the virtual machine instance;
attach the image file to the virtual machine instance; and
power on the virtual machine instance.

2. The system of claim 1, wherein the virtual machine instance is configured to:
adjust one or more customizable settings of the virtual machine instance based, at least in part, on the image file.

3. The system of claim 2, wherein the hypervisor independent interface software layer is further configured to:
pre-install a customization tool in a boot image of the virtual machine instance.

4. The system of claim 3, wherein the customization tool is configured to:
discover the image file responsive to powering on the virtual machine instance; and
adjust the one or more customizable settings.

5. The system of claim 1, wherein to generate the virtual machine instance, the interface software layer is configured to:
determine a customization tool associated with the operating system;
access the customization tool library associated with the customization tool; and
generate the image file based, at least in part, on the customization tool library.

6. The system of claim 5, wherein the customization tool library comprises operating system specific customizable settings for the virtual machine instance.

7. The system of claim 1, wherein the image file comprises an ISO file or an XML file.

8. A method of instantiating a customized virtual machine, the method comprising:
determining configuration information and an operating system for a virtual machine to be created;
receiving an instruction to create the virtual machine through a hypervisor independent interface software layer;
converting the instruction to create the virtual machine into a hypervisor specific command;
creating a virtual machine instance responsive to the hypervisor specific command;
generating an image file by accessing a customization tool library from a plurality of customization tool libraries based, at least in part, on the configuration information and the operating system for the virtual machine;
attaching the image file to the virtual machine; and
powering on the virtual machine instance.

9. The method of claim 8, wherein creating the virtual machine instance comprises:
determining a customization tool associated with the operating system; and
pre-installing the customization tool associated with the operating system in a boot image of the virtual machine instance.

10. The method of claim 9, wherein generating the image file comprises:
generating the image file based, at least in part, on the customization tool library.

11. The method of claim 10, further comprising:
responsive to powering on the virtual machine instance, adjusting one or more customizable settings of the virtual machine instance based, at least in part, on the image file.

12. The method of claim 8, wherein the configuration information comprises custom driver information, custom software information, or a combination thereof.

13. The method of claim 8, wherein the image file comprises an ISO file or an XML file.

14. A method comprising:
providing configuration information for a virtual machine instance to a hypervisor agnostic interface software layer; and
providing an instruction to create the virtual machine instance through the hypervisor agnostic interface software layer wherein the hypervisor agnostic interface software layer is configured to:
determine an operating system for the virtual machine instance;
convert the instruction to create the virtual machine instance into a hypervisor specific command;
create the virtual machine instance responsive to the hypervisor specific command;
generate an image file by accessing a customization tool library from a plurality of customization tool libraries based, at least in part, on the configuration information and the operating system for the virtual machine instance;
attach the image file to the virtual machine instance; and
power on the virtual machine instance.

15. The method of claim 14, wherein the hypervisor agnostic interface software layer is a virtual machine configured to execute on a computing node.

16. The method of claim 15, wherein the instruction to create the virtual machine instance is provided without specifying a type of hypervisor executing on the computing node.

17. The method of claim 14, further comprising:
providing the operating system for the virtual machine instance through the hypervisor agnostic interface software layer.

18. The method of claim 14, wherein the hypervisor agnostic interface software layer is further configured to:
determine a customization tool associated with the operating system; and
pre-install the customization tool associated with the operating system in a boot image of the virtual machine instance.

19. The method of claim 18, wherein the hypervisor agnostic interface software layer is further configured to:
generate the image file based, at least in part, on one or more customizable settings contained in the customization tool library.

20. The method of claim 14, wherein the hypervisor agnostic interface software layer is further configured to:
adjust one or more customizable settings of the virtual machine instance based, at least in part, on the image file, responsive to powering on the virtual machine instance.

21. A method comprising:
determining a type of a hypervisor configured to execute on a computing node;
receiving a command having a first format through a hypervisor agnostic interface software layer;
converting the command having the first format to a command having a second format using a hypervisor abstraction library associated with the type of the hypervisor; and
providing the command having the second format to the hypervisor.

22. The method of claim 21, wherein the hypervisor abstraction library is selected from a plurality of stored hypervisor abstraction libraries, and each stored hypervisor abstraction library is associated with a different type of hypervisor.

23. The method of claim 21, further comprising:
storing the type of the hypervisor in a cache memory.

24. The method of claim 21, further comprising:
executing, by the hypervisor, the command having the second format.

25. The method of claim 21, wherein the hypervisor abstraction library comprises translation information to convert commands having the first format to commands having the second format.

26. The method of claim 25, wherein converting the command comprises:
querying the hypervisor abstraction library to identify the command having the first format in the hypervisor abstraction library; and
determining the command having the second format based, at least in part, on the translation information.

27. A system comprising:
a computing node configured to execute a hypervisor; and
a hypervisor agnostic interface software layer configured to execute on the computing node, wherein the interface software layer is configured to:
determine a type of the hypervisor configured to execute on the computing node;
receive a command having a first format through the hypervisor agnostic interface software layer;
converting the command having the first format to a command having a second format using a hypervisor abstraction library associated with the type of the hypervisor; and
providing the command having the second format to the hypervisor.

28. The system of claim 27, wherein the hypervisor abstraction library is selected from a plurality of stored hypervisor abstraction libraries, and each stored hypervisor abstraction library is associated with a different type of hypervisor.

29. The system of claim 27, wherein the hypervisor agnostic interface software layer is further configured to:
store the type of the hypervisor in a cache memory.

30. The system of claim 27, wherein the hypervisor agnostic interface software layer is further configured to:
execute, by the hypervisor, the command having the second format.

31. The system of claim 27, wherein the hypervisor abstraction library comprises translation information to convert commands having the first format to commands having the second format.

32. The system of claim 31, wherein the hypervisor agnostic interface software layer is further configured to convert the command by:
querying the hypervisor abstraction library to identify the command having the first format in the hypervisor abstraction library; and
determining the command having the second format based, at least in part, on the translation information.
